(19) United States
(12) Patent Application Publication
(10) Pub. No.: US 2026/0042139 A1
(43) Pub. Date: Feb. 12, 2026

(54) WIRE GRIPPER AND WIRE TENSIONING DEVICE

(71) Applicant: NAGAKI SEIKI CO., LTD., Osaka (JP)

(72) Inventor: Kosuke OKAMOTO, Osaka (JP)

(21) Appl. No.: 19/101,647

(22) PCT Filed: Apr. 10, 2023
(86) PCT No.: PCT/JP2023/014625

§ 371 Date: Feb. 6, 2025

(30) Foreign Application Priority Data
Aug. 8, 2022 (JP) 2022-126457

(51) Int. Cl. B21F 9/00; H02G 1/04

(52) U.S. Cl. CPC B21F 9/002; H02G 1/04

(57) ABSTRACT

A wire gripper is provided which is used when grasping a wire-shaped body. The wire gripper comprises a wire gripping part, a displacement mechanism, and a driving mechanism. The wire gripping part has a first wire gripping body and a second wire gripping body that is disposed oppositely from the first wire gripping body. The displacement mechanism is configured to relatively displace the first wire gripping body and the second wire gripping body to a first position for grasping the wire-shaped body and a second position for releasing the grasp of the wire-shaped body. The driving mechanism has a motor that drives the displacement mechanism.

### CROSS REFERENCE TO RELATED APPLICATIONS

This application is a 371 U.S. National Phase of International Application No. PCT/JP2023/014625, filed on Apr. 10, 2023, which claims priority to Japanese Patent Application No. 2022-126457, filed Aug. 8, 2022. The entire disclosures of the above applications are incorporated herein by reference.

### BACKGROUND

### Technical Field

The present disclosure relates to a wire gripper and a wire tensioning device.

### Related Art

When performing wire tensioning work in electrical construction, railway maintenance, and fruit tree trellis creation, it is common to use a wire gripper that grips wire-like bodies such as wires and electric wires. JP2018-11495A discloses a wire gripper that grips a wire-like body by rotating a bolt.

The wire tensioning work is often performed at high places, thus requiring a wire gripper that has easy operability to enable the work to be performed quickly and safely. In view of the above circumstances, the present disclosure provides a wire gripper and a wire tensioning device with easy operability.

### SUMMARY

According to an aspect of the present disclosure, a wire gripper adapted to be used to grip a wire-like body is provided. The wire gripper includes a wire gripping portion, a displacement mechanism, and a drive mechanism. The wire gripping portion includes a first wire gripping body, and a second wire gripping body disposed opposite to the first wire gripping body. The displacement mechanism is configured to relatively displace the first wire gripping body and the second wire gripping body between a first position allowing the wire-like body to be gripped and a second position allowing the gripped wire-like body to be released. The drive mechanism includes a motor that actuates the displacement mechanism.

According to such an aspect, the wire gripper can be operated easily, and the wire tensioning work can be performed quickly and safely.

### BRIEF DESCRIPTION OF THE DRAWINGS

FIG. 1 is a front view showing an embodiment of a wire tensioning device of the present disclosure.

FIG. 2 is a perspective view showing a configuration of a support on the left side in FIG. 1.

FIG. 3 is a perspective view showing a configuration of a support on the right side in FIG. 1.

FIG. 4 is a perspective view showing the first embodiment of a wire gripper of the present disclosure.

FIG. 5 is a front view of the wire gripper shown in FIG. 4.

FIG. 6 is an exploded perspective view showing a configuration of a wire gripping portion and a displacement mechanism.

FIG. 7 is an exploded perspective view showing a configuration of a displacement mechanism.

FIG. 8 is an exploded perspective view showing a configuration of a drive mechanism.

FIG. 9 is a block diagram showing a configuration of a control board.

FIG. 10 is a perspective view showing the second embodiment of the wire gripper of the present disclosure.

FIG. 11 is a front view showing a state in which the wire gripping portion and the displacement mechanism are removed from the wire gripper shown in FIG. 10.

FIG. 12 is a perspective views showing a configuration of a drive mechanism.

FIG. 13 is a side view showing a configuration of a drive mechanism.

### DETAILED DESCRIPTION

Hereinafter, an embodiment of the present disclosure will be described with reference to drawings. Various features described in the embodiment below can be combined with each other.

A program for realizing a software in the present embodiment may be provided as a non-transitory computer readable storage medium that can be read by a computer, may be provided for download from an external server, or may be provided in such a manner that the program can be activated on an external computer to realize function thereof on a client terminal (so-called cloud computing).

A term “unit” in the present embodiment may include, for example, a combination of a hardware resource implemented as circuits in a broad sense and information processing of software that can be concretely realized by the hardware resource. Furthermore, various kinds of information are described in the present embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

The circuit in a broad sense is a circuit realized by at least properly combining a circuit, circuitry, a processor, a memory, and the like. In other words, a circuit includes an application specific integrated circuit (ASIC), a programmable logic device (e.g., simple programmable logic device (SPLD), a complex programmable logic device (CLPD), field programmable gate array (FPGA), and the like.

### Wire Tensioning Device

First, a wire tensioning device of the present disclosure will be described.

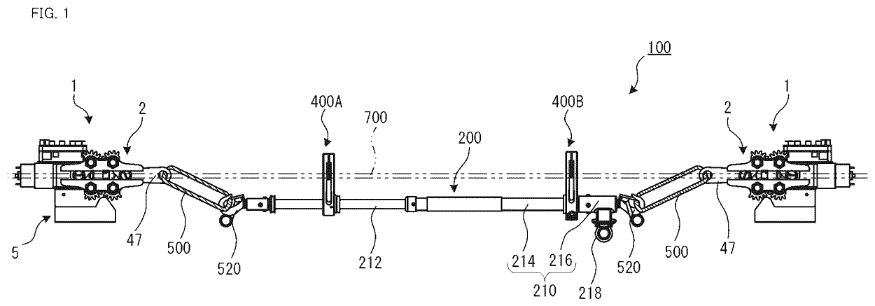

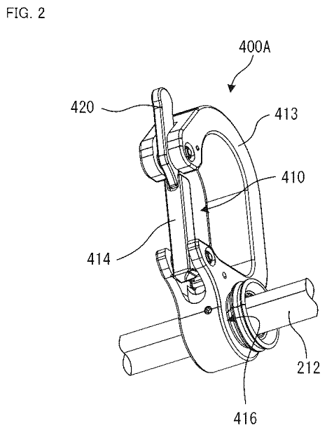

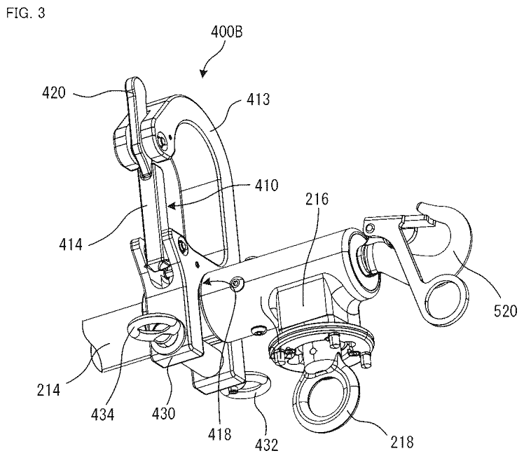

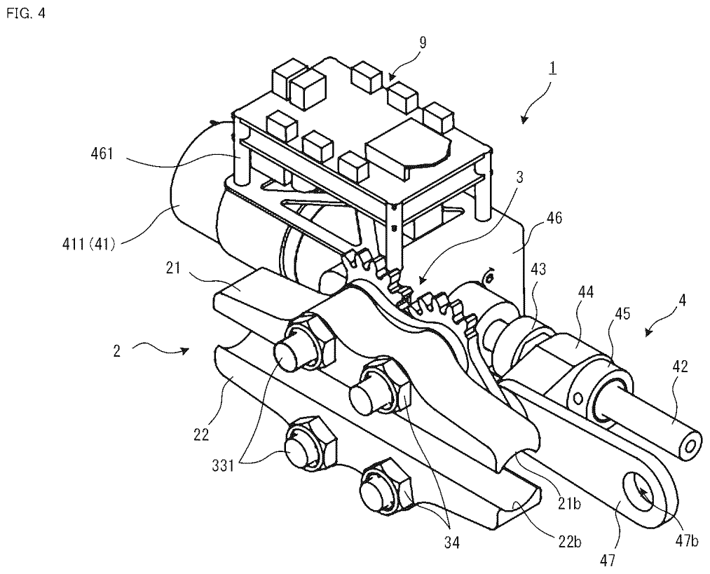

FIG. 1 is a front view showing an embodiment of a wire tensioning device of the present disclosure. FIG. 2 and FIG. 3 are perspective views showing a configuration of a support in FIG. 1, respectively. In the following description, an upper side is referred to as “up” or “upward” and a lower side is referred to as “down” or “downward” in FIG. 1 to FIG. 3 (the same applies to FIG. 4 to FIG. 8). In addition, a right side is referred to as “right” or “right side” and a left side is referred to as “left” or “left side” in FIG. 1 to FIG. 3 (the same applies to FIG. 4 to FIG. 8). The wire tensioning device (also referred to as “strain rod”) 100 shown in FIG. 1 is used, for example, to cut a coated electric wire 700 in an aerial state. In FIG. 1, the coated electric wire 700 is indicated by two-dot chain lines.

This wire tensioning device 100 includes a pair of wire grippers 1 for gripping the coated electric wire 700 (overhead wire) and a long expander 200 whose both ends are coupled to these wire grippers 1 via coupling tools 500.

The expander 200 is configured such that the longitudinal dimension thereof can be expanded or contracted by operating an operation portion 218 provided on the right side (another side) of the expander 200 in the longitudinal direction.

As shown in FIG. 1, the expander 200 includes a body cylinder portion 210 having a cylindrical shape and a small-diameter cylindrical moving shaft portion 212 inserted in the body cylinder portion 210 so as to be relatively movable in the longitudinal direction.

The body cylinder portion 210 includes a cylindrical portion 214 made of, for example, aluminum or FRP (fiber-reinforced plastic), and a moving portion 216 fixed at the end of the cylindrical portion 214.

The moving portion 216 has a casing made of, for example, aluminum alloy, and a gear transmission mechanism (not shown) housed in the casing. The gear transmission mechanism is coupled to the operation portion 218 that protrudes from the bottom surface of the casing and is rotated.

The gear transmission mechanism is coupled to a screw shaft extending in the longitudinal direction in the cylindrical portion 214. A nut (not shown) provided at the end of the moving shaft portion 212 on the body cylinder portion 210 side is screwed with this screw shaft. The moving shaft portion 212 is formed of, for example, FRP.

When expanding and contracting the expander 200, a remote control tool (an indirect tool) is engaged with the operation portion 218, and the operation portion 218 is rotated by the remote control tool. This allows the screw shaft in the cylindrical portion 214 to be driven to rotate, and the moving shaft portion 212, whose nut provided at the end is screwed with the screw shaft, moves along the axial direction. As a result, the moving shaft portion 212 comes in and out from the body cylinder portion 210, and the expander 200 is configured to expand or contract.

The end of the expander 200 on the body cylinder portion 210 side and the end of the expander 200 on the moving shaft portion 212 side are each provided with a fixing member 520 capable of locking a coupling tool 500.

The wire tensioning device 100 includes a pair of supports 400A and 400B attached to the expander 200.

As shown in FIG. 2 and FIG. 3, the supports 400A and 400B each include a substantially C-shaped support body 413 having an opening 410 on one side and a closing piece 414 which closes the opening 410 of the support body 413. With such a configuration, after introducing the coated electric wire 700 into the inside of the support body 413 through the opening 410, the opening 410 of the support body 413 is closed with the closing piece 414, so that the supports 400A and 400B can support the coated electric wire 700.

In addition, an engagement piece 420 that engages with the closing piece 414 is rotatably provided in a state in which the opening 410 is closed by the closing piece 414 at the end of the support body 413 facing the opening 410.

As shown in FIG. 2, a through hole 416 through which the expander 200 (moving shaft portion 212) is inserted is formed in the lower part of the support body 413 in the support 400A.

On the other hand, as shown in FIG. 3, a through hole 418 through which the expander 200 (cylindrical portion 214) is inserted is formed in the lower part of the support body 413 in the support 400B.

In addition, the support 400B is provided with a fixing portion 430 at the lower part of the support body 413 for fixing the expander 200 at a desired position in the longitudinal direction and at a rotation angle around a predetermined axis. Furthermore, operation portions 432 and 434 are provided on both sides for operating the fixing portion 430 with a remote control tool.

With this support 400B, an operation for changing the direction of the end of the coated electric wire 700 on the right side after cutting (sorting operation) can be performed so that the ends of the coated electric wire 700 after cutting do not come into contact with each other.

Such a wire tensioning device 100 (the expander 20 having a pair of wire grippers 1 coupled to both ends thereof) is used, for example, in the following manner.

First, the pair of supports 400A and 400B are hooked onto the coated electric wire 700. Next, the wire gripper 1 on the right side grips a predetermined portion of the coated electric wire 700, and the wire gripper 1 on the left side grips a predetermined portion of the coated electric wire 700.

Then, the operation portion 218 is operated to contract the longitudinal dimension of the expander 200, and the pair of wire grippers 1 gripping the coated electric wire TOO are brought closer to each other. This allows the coated electric wire 700 to be kept taut outside the wire gripper 1 of the coated electric wire 700 and to be loosened in the portion of the coated electric wire 700 between the two wire grippers 1, and then the loosened portion of the coated electric wire 700 is cut with a cutting tool for an indirect live wire.

On the other hand, the operation portion 218 can be operated to extend the longitudinal dimension of the expander 200 and separate the pair of wire grippers 1 gripping the coated electric wire 700.

### Wire Gripper

Next, the wire gripper of the present disclosure will be described.

### First Embodiment

First, the first embodiment of the wire gripper of the present disclosure will be described.

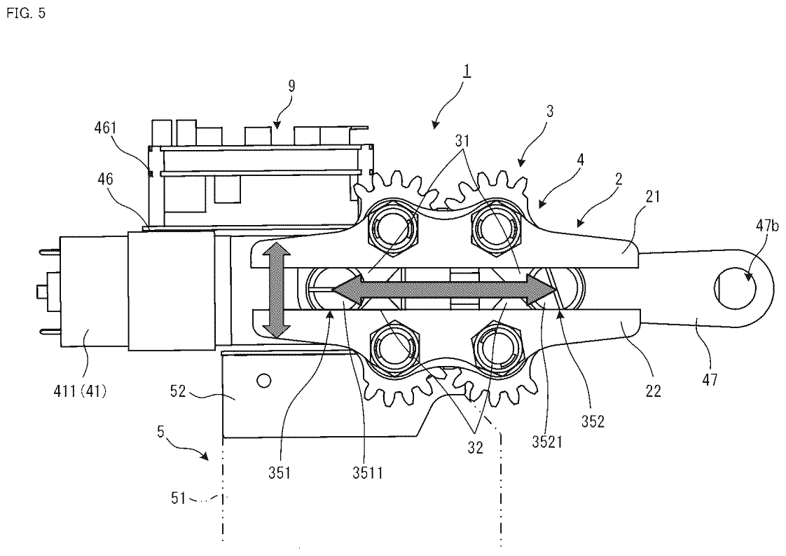

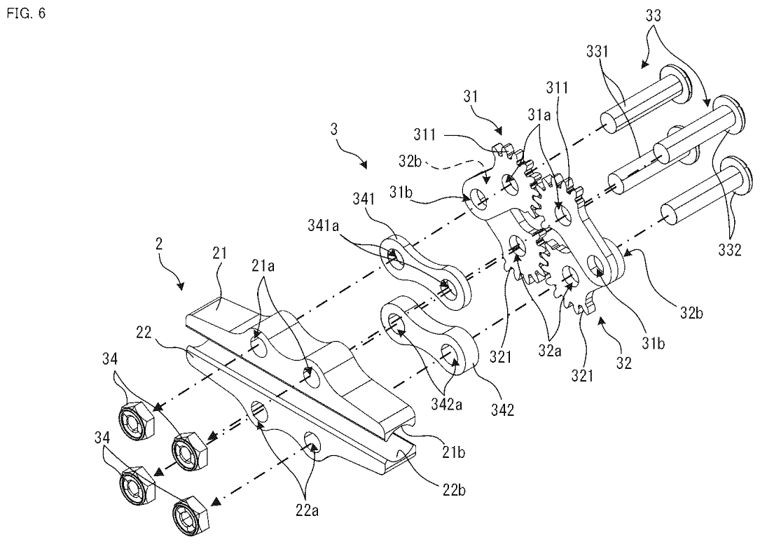

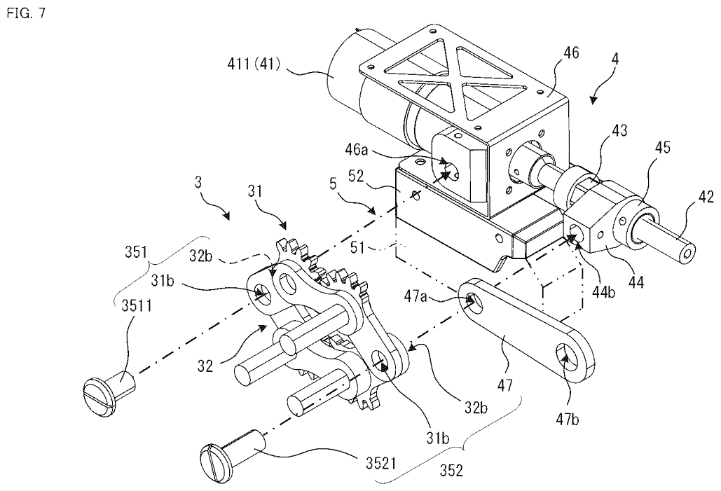

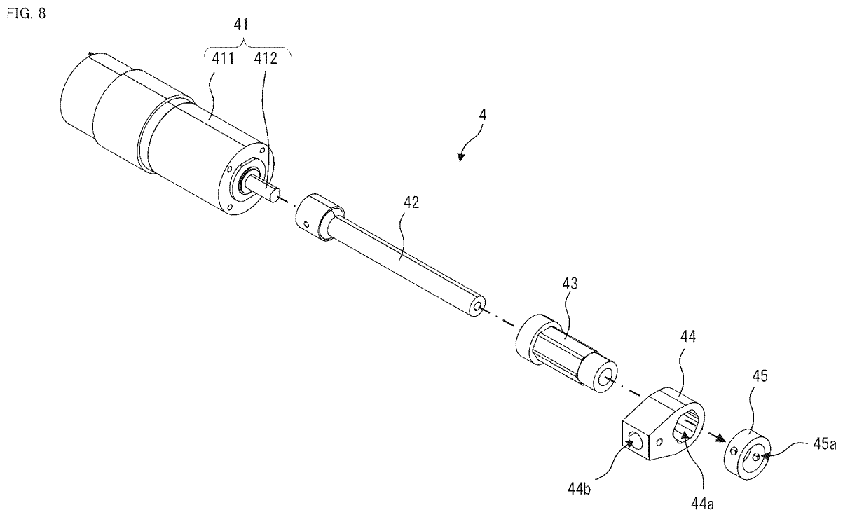

FIG. 4 is a perspective view showing the first embodiment of the wire gripper of the present disclosure. FIG. 5 is a front view of the wire gripper shown in FIG. 4. FIG. 6 is an exploded perspective view showing a configuration of a wire gripping portion and a displacement mechanism. FIG. 7 is an exploded perspective view showing a configuration of a displacement mechanism. FIG. 8 is an exploded perspective view showing a configuration of a drive mechanism. The wire gripper 1 shown in FIG. 4 is a device adapted to be used to grip the coated electric wire (wire-like body) 700. The wire gripper 1 includes a wire gripping portion 2, a displacement mechanism 3, a drive mechanism 4, a power supply part 5, and a control board 9.

The wire gripping portion 2 includes a first wire gripping body 21 and a second wire gripping body 22 disposed opposite to the first wire gripping body 21.

The first wire gripping body 21 and the second wire gripping body 22 are each made of a block-shaped member. As shown in FIG. 6, the first wire gripping body 21 is provided with two through holes 21a penetrating in its thickness direction, and the second wire gripping body 22 is provided with two through holes 22a penetrating in its thickness direction.

In addition, an arc-shaped groove 21b is formed on the lower surface of the first wire gripping body 21, and an arc-shaped groove 22b is formed on the upper surface of the second wire gripping body 22.

The first wire gripping body 21 and the second wire gripping body 22 are displaced at a first position where they are brought close to each other to allow the coated electric wire 700 to be gripped. The first wire gripping body 21 and the second wire gripping body 22 are displaced at a second position where they are separated from each other to allow the gripped coated electric wire 700 to be released.

In addition, the groove 21b and the groove 22b may be provided with a non-slip means to prevent the coated electric wire 700 from slipping when the coated electric wire 700 is gripped between them. Such non-slip means may include the formation of pointed fine protrusions, the formation of fine protruded stripes extending in the lateral direction, the affixing of rubber members, and the like.

The displacement mechanism 3 is configured to relatively displace the first wire gripping body 21 and the second wire gripping body 22 between the first position and the second position. In the present embodiment, both the first wire gripping body 21 and the second wire gripping body 22 are configured to be displaced. The displacement mechanism 3 may be configured to displace the second wire gripping body 22 relative to the fixed first wire gripping body 21, or the displacement mechanism 3 may be configured to displace the first wire gripping body 21 relative to the fixed second wire gripping body 22.

Specifically, the displacement mechanism 3 includes a pair of first link pieces 31 and a pair of second link pieces 32. The first link pieces 31 and the second link pieces 32 are each formed of a narrow plate piece. As shown in FIG. 6, each first link piece 31 includes a through hole 31a formed at its upper end and a through hole 31b formed at its lower end. On the other hand, each second link piece 32 includes a through hole 32a formed at its lower end and a through hole 32b formed at its upper end.

A thread portion 331 of a bolt 33 is inserted into the through hole 31a of the first link piece 31, and a screw head 332 contacts the first link piece 31. Then, the thread portion 331 is inserted through a through hole 341a of a spacer 341 and the through hole 21a of the first wire gripping body 21, and a nut 34 is screwed with a portion protruding from the first wire gripping body 21. As a result, the pair of first link pieces 31 is rotatably attached to the first wire gripping body 21.

Similarly, the thread portion 331 of the bolt 33 is inserted through the through hole 32a of the second link piece 32, and the screw head 332 contacts the second link piece 32. The thread portion 331 is inserted through a through hole 342a of a spacer 342 and the through hole 22a of the second wire gripping body 22. The nut 34 is screwed with the portion protruding from the second wire gripping body 22. As a result, the pair of second link pieces 32 is rotatably attached to the second wire gripping body 22.

In addition, tooth portions 311 are formed on the periphery (the end on the first wire gripping body 21 side) of the through holes 31a of the pair of first link pieces 31 and are meshed with each other. Similarly, tooth portions 321 are formed on the periphery (the end on the second wire gripping body 22 side) of the through holes 32a of the pair of second link pieces 32 and are meshed with each other. This allows the first link pieces 31 and the second link pieces 32 to rotate more reliably. As shown in FIG. 7, the first link piece 31 on the left side (one of the first link pieces 31) and the corresponding second link piece 32 on the left side (one of the second link pieces 32) are rotatably connected by a first connection structure 351. Furthermore, the first link piece 31 on the right side (another of the first link pieces 31) and the corresponding second link piece 32 on the right side (another of the second link pieces 32) are rotatably connected by a second connection structure 352. That is, the displacement mechanism 3 includes the first connection structure 351 and the second connection structure 352.

Specifically, the first connection structure 351 includes the through hole 31b of the first link piece 31, the through hole 32b of the second link piece 32, and a bolt 3511. On the other hand, the second connection structure 352 includes the through hole 31b of the first link piece 31, the through hole 32b of the second link piece 32, and a bolt 3521.

The drive mechanism 4 can actuate the displacement mechanism 3. Specifically, the drive mechanism 4 is configured to bring the first connection structure 351 and the second connection structure 352 close to each other and to separate the first connection structure 351 from the second connection structure 352.

As shown in FIG. 7 and FIG. 8, the drive mechanism 4 includes a motor 41 having a motor body 411 and a rotary shaft 412, a screw shaft 42 connected to the rotary shaft 412 of the motor 41, a slider 43 screwed with the screw shaft 42, a coupling member 44 attached to the slider 43, and a fixing member 45 that prevents the coupling member 44 from detaching from the slider 43.

As shown in FIG. 8, the coupling member 44 includes an engagement hole 44a penetrating in its thickness direction, and the fixing member 45 includes an annular member having an engagement hole 45a. The slider 43 is inserted through the engagement hole 44a of the coupling member 44, and the fixing member 45 is fitted onto the portion of the slider 43 protruding from the coupling member 44. Consequently, the coupling member 44 is fixed to the slider 43.

Furthermore, the coupling member 44 has a screw hole 44b formed on the displacement mechanism 3 side. The tip of the bolt 3521 of the second connection structure 352 is screwed with this screw hole 44b. As a result, the second connection structure 352 is fixed to the slider 43 via the coupling member 44.

The second connection structure 352 further includes a connecting member 47 provided between the displacement mechanism 3 and the coupling member 44. The connecting member 47 is formed of a narrow plate piece.

The connecting member 47 includes a through hole 47a formed at the left-side end thereof and a through hole 47b formed at the right-side end thereof as shown in FIG. 7. The bolt 3521 is inserted into the through hole 47a and screwed with the screw hole 44b of the coupling member 44, thereby coupling the connecting member 47 to the displacement mechanism 3 (second connection structure 352). On the other hand, the coupling tool 500 of the wire tensioning device 100 is connected to the through hole 47b.

The second connection structure 352 can be displaced in a direction separate from the first connection structure 351 by pulling the connecting member 47.

Furthermore, as shown in FIG. 7, the drive mechanism 4 includes a case 46 that houses the motor 41. The case 46 has a screw hole 46a formed on the displacement mechanism 3 side. The tip portion of the bolt 3511 of the first connection structure 351 is screwed with this screw hole 46a. Thereby, the first connection structure 351 is fixed to the case 46 (motor 41).

With such a configuration of the drive mechanism 4, when the motor 41 is actuated to rotate the rotary shaft 412, the screw shaft 42 also rotates integrally with the rotary shaft 412. As a result, the slider 43 and the coupling member 44 are configured to reciprocate along the screw shaft 42.

In the displacement mechanism 3, the first connection structure 351 is coupled to the motor body 411 via the case 46, and the second connection structure 352 is coupled to the slider 43 via the coupling member 44. Thus, the drive mechanism 4 reciprocates the slider 43 and the coupling member 44 along the screw shaft 42 by the rotation of the motor 41, thereby enabling the first connection structure 351 and the second connection structure 352 to be brought close to each other and to be separated from each other.

When the first connection structure 351 and the second connection structure 352 are separated from each other, the first wire gripping body 21 and the second wire gripping body 22 are brought close to each other and can be displaced to the first position (see a thick arrow in the lateral direction in FIG. 5). On the other hand, when the first connection structure 351 and the second connection structure 352 are brought close to each other, the first wire gripping body 21 and the second wire gripping body 22 are separated from each other and can be displaced to the second position (see a thick arrow in the vertical direction in FIG. 5).

The case 46 that houses the motor 41 (motor body 411) is provided with a power supply part 5 at the lower portion thereof. The power supply part 5 includes a battery 51 and a battery mounting portion 52 into which the battery 51 is detachably mounted. The battery mounting portion 52 is fixed to the case 46. The power supply part 5 can supply power to at least the motor 41.

The battery 51 may be, for example, a primary battery such as a dry cell or solar cell, or a secondary battery such as a lithium ion battery.

The case 46 includes a support stand 461 at its upper portion, and a control board 9 is mounted on the support stand 461. A cover (not shown) preferably covering the control board 9 is provided.

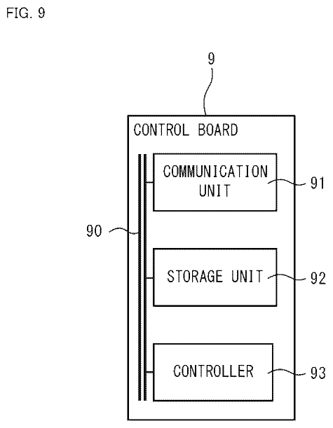

FIG. 9 is a block diagram showing a configuration of the control board. The control board 9 shown in FIG. 9 is, for example, a dedicated control device that controls at least the motor 41, and includes a communication unit 91, a storage unit 92, and a controller 93, which are electrically connected via a communication bus 90. In addition to the motor 41, the power supply part 5 is electrically connected to the control board 9.

The communication unit 91 is configured to transmit various electrical signals from the control board 9 to an external component. Furthermore, the communication unit 91 is configured to receive various electrical signals from an external component to the control board 9. More preferably, the communication unit 91 has a network communication function, thereby various information can be communicated with an external apparatus via a network such as the Internet.

The communication unit 91 may be preferably wired communication means such as USB, IEEE1394, Thunderbolt (registered trademark), wired LAN network communication, and the like, but may include wireless LAN network communication, mobile communication such as 3G/LTE/5G, Bluetooth (registered trademark) communication, and the like as needed. In other words, more preferably, the communication unit 91 is implemented as a set of these communication means.

The storage unit 92 is configured to store various information as defined by the above description.

This may be implemented as a storage device such as a solid state drive (SSD) storing various programs related to the wire gripper 1 that are executed by the controller 93, or as a memory such as a random access memory (RAM) that stores temporarily necessary information (argument, sequence, etc.) for program operation.

The storage unit 92 stores various programs, variables, etc. related to the wire gripper 1 that are executed by the controller 93. Particularly preferably, information on the construction plan to be performed using the wire gripper 1 is stored.

The controller 93 processes and controls overall operation pertaining to the wire gripper 1.

The controller 93 is, for example, an unshown central processing unit (CPU). The controller 93 realizes various functions pertaining to the wire gripper 1 by reading a predetermined program stored in the storage unit 92. In other words, the controller 93 as an example of hardware is configured to concretely realize information processing of software stored in the storage unit 92.

The controller 93 is not limited to being a single controller but may be implemented with a plurality of controllers 93 for each function. Moreover, a combination thereof may be applied.

Next, the use of the wire gripper 1 (wire tensioning device 100) will be described.

[1] First, the supports 400A and 400B are hooked onto the coated electric wire 700. Then, a pair of wire grippers 1 coupled to both ends of the expander 200 is mounted to the coated electric wire 700 using a remote control tool. Specifically, the first wire gripping body 21 and the second wire gripping body 22 are set at the second position, the coated electric wire 700 is inserted between them, and the first wire gripping body 21 is hooked onto the coated electric wire 700.

[2] Next, an external terminal (not shown) is used to actuate the motor 41 to rotate the rotary shaft 412 in a predetermined direction. Consequently, the screw shaft 42 connected to the rotary shaft 412 also rotates, and the slider 43 screwed with the screw shaft 42 moves along the longitudinal direction of the screw shaft 42 in a direction separate from the motor body 411.

At this time, the first connection structure 351 is coupled to the motor body 411, and the second connection structure 352 is coupled to the slider 43. This causes the second connection structure 352 to be separated from the first connection structure 351.

As a result, the upper end of the first link piece 31 on the left side rotates clockwise around the thread portion 331 of the bolt 33, and the upper end of the first link piece 31 on the right side rotates counterclockwise around the thread portion 331 of the bolt 33. Then, the first wire gripping body 21 into which the two thread portions 331 are inserted is displaced downwardly in FIG. 5.

On the other hand, the lower end of the second link piece 32 on the left side rotates counterclockwise around the thread portion 331 of the bolt 33, and the lower end of the second link piece 32 on the right side rotates clockwise around the thread portion 331 of the bolt 33. Then, the second wire gripping body 22 into which the two thread portions 331 are inserted is displaced upwardly in FIG. 5.

In such a manner, the first wire gripping body 21 and the second wire gripping body 22 are displaced to the first position so that they are brought close to each other, and the coated electric wire 700 is gripped. This allows the pair of wire grippers 1 to be fixed to the coated electric wire 700.

At this time, the actuation of the motor 41 is stopped by operating an external terminal. Consequently, the displacement of the first wire gripping body 21 and the second wire gripping body 22 to the first position is maintained and the state in which the coated electric wire 700 is gripped can be maintained.

[3] When cutting the coated electric wire 700, the operation portion 218 is operated by the remote control tool to contract the longitudinal dimension of the expander 200, thereby bringing the wire grippers 1 close to each other. Consequently, the coated electric wire 700 can be in a taut state on the outer side of the wire gripper 1, and in the portion of the coated electric wire 700 between the two wire grippers 1, the coated electric wire 700 can be loosened.

At this time, the connecting members 47 of the two wire grippers 1 are pulled in a direction in which they are brought close to each other, so that the first wire gripping body 21 and the second wire gripping body 22 tend to displace in a direction in which they are brought close to each other. As a result, the coated electric wire 700 can be gripped more firmly by the first wire gripping body 21 and the second wire gripping body 22.

[4] After completing the work, the operation portion 218 is operated by the remote control tool to extend the longitudinal dimension of the expander 200, and the wire grippers 1 are separated from each other.

Thereafter, the motor 41 is actuated using an external terminal to rotate the rotary shaft 412 in the opposite direction to the above. This allows the first wire gripping body 21 and the second wire gripping body 22 to be displaced from the first position to the second position, thereby releasing the gripping of the coated electric wire 700.

Finally, the wire tensioning device 100 is removed from the coated electric wire 700 by using a remote control tool.

### Second Embodiment

Next, the second embodiment of the wire gripper of the present disclosure will be described.

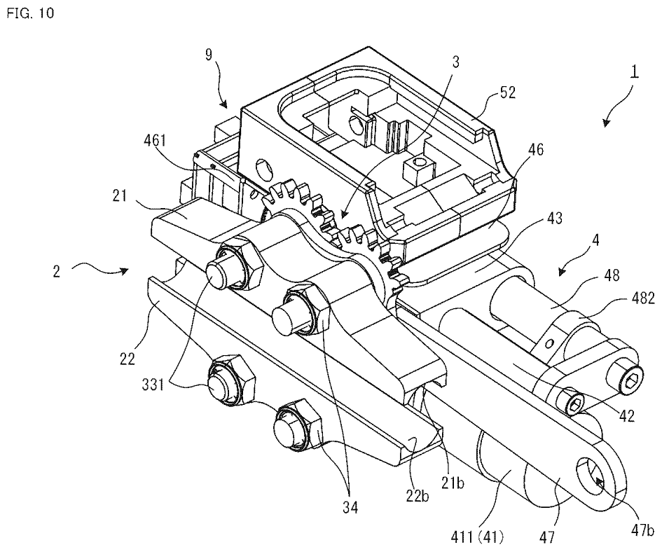

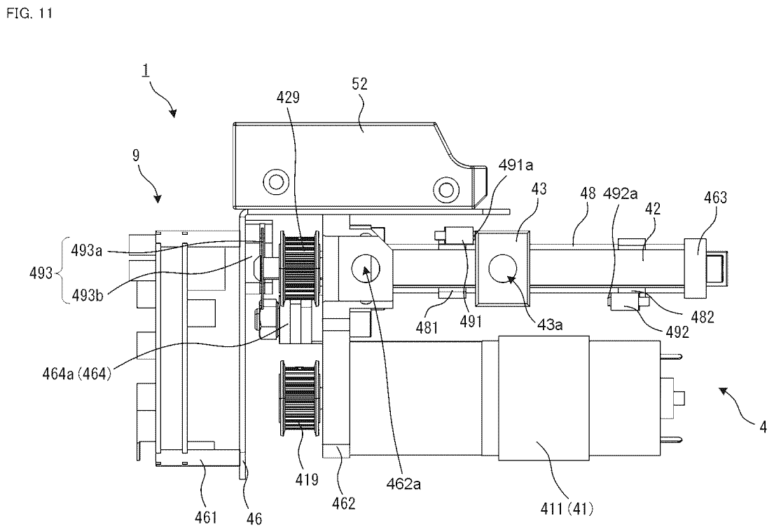

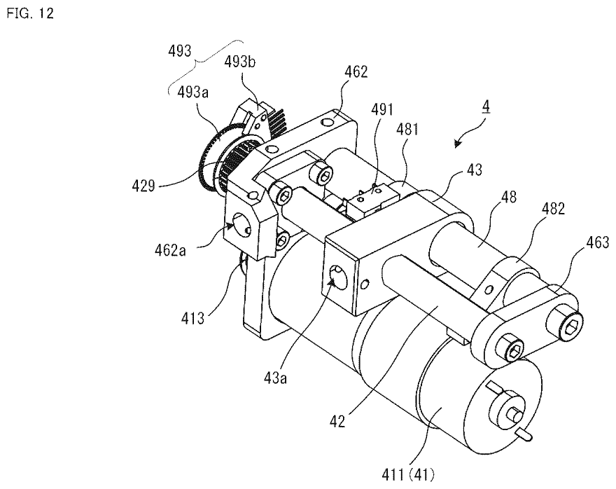

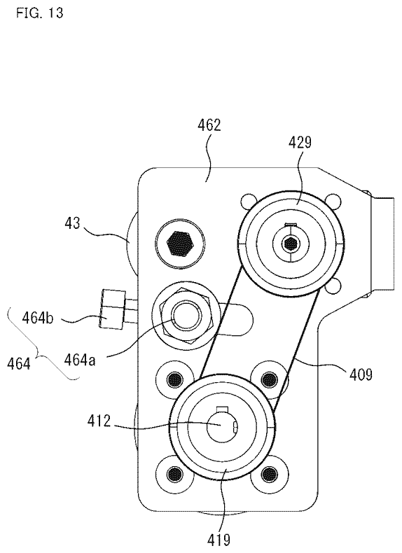

FIG. 10 is a perspective view showing the second embodiment of the wire gripper of the present disclosure. FIG. 11 is a front view showing a state in which the wire gripping portion and the displacement mechanism are removed from the wire gripper shown in FIG. 10. FIG. 12 is a perspective views showing a configuration of a drive mechanism. FIG. 13 is a side view showing a configuration of a drive mechanism. In the following description, an upper side is referred to as “up” or “upward” and a lower side is referred to as “down” or “downward” in FIG. 10 to FIG. 13. In addition, a right side is referred to as “right” or “right side” and a left side is referred to as “left” or “left side” in FIG. 10 to FIG. 12.

Hereinafter, as for the wire gripper of the second embodiment, a description will be mainly given of differences from the above-described wire gripper of the first embodiment, and the description of similar matters will be omitted. The wire gripper 1 of the second embodiment is similar to the wire gripper 1 of the first embodiment, mainly except that the configuration of the drive mechanism 4 is different.

The drive mechanism 4 shown in FIG. 10 and FIG. 11 includes the screw shaft 42 provided adjacent to the rotary shaft 412 of the motor 41, a rotational force transmission mechanism that transmits a rotational force of the rotary shaft 412 of the motor 41 to the screw shaft 42, and the slider 43 that moves along the screw shaft 42 by the rotation of the screw shaft 42.

As shown in FIG. 12, the drive mechanism 4 further includes a guide shaft 48. Each of the left side portions of the motor body 411 of the motor 41, the screw shaft 42, and the guide shaft 48 is supported by a support plate 462, and each of the right side portions of the screw shaft 42 and the guide shaft 48 is supported by a support plate 463.

A screw hole 462a formed in the support plate 462 is screwed with the tip portion of the bolt 3511 of the first connection structure 351, and a screw hole 43a formed in the slider 43 is screwed with the tip portion of the bolt 3521 of the second connection structure 352. With such a configuration, the first connection structure is fixed to the motor 41 and the second connection structure is fixed to the slider 43.

In addition, in the middle of the guide shaft 48 in the longitudinal direction (axial direction), an arm 481 is fixed to the left side thereof and an arm 482 is fixed to the right side thereof. Each of the arms 481 and 482 is provided so as to protrude toward the screw shaft 42 side.

A microswitch 491 is fixed to the upper side of the arm 481, and a microswitch 492 is fixed to the lower side of the arm 482. The microswitches 491 and 492 are each arranged so that their push buttons 491a and 492a face the slider 43. The slider 43 moves along the screw shaft 42 and pushes the push buttons 491a and 492a, thus enabling the microswitches 491 and 492 to be turned on.

As shown in FIG. 11 and FIG. 13, a pulley 419 is fixed to the rotary shaft 412 of the motor 41, and a pulley 429 is fixed to the screw shaft 42. As shown in FIG. 13, a timing belt 409 is looped around the pulley 419 and the pulley 429.

With such a configuration, the rotational force of the rotary shaft 412 of the motor 41 can be transmitted to the screw shaft 42 via the pulley 419, the pulley 429 and the timing belt 409. That is, the rotational force transmission mechanism comprises the pulley 419, the pulley 429, and the timing belt 409.

In addition, a tension adjustment mechanism 464 is provided on the support plate 462 to adjust the tension of the timing belt 409. The tension adjustment mechanism 464 comprises a pressure roller 464a that presses the timing belt 409 and a position adjustment screw 464b that adjusts the position of the pressure roller 464a relative to the timing belt 409.

The position of the pressure roller 464a relative to the timing belt 409 can be changed by adjusting the degree of tightening of the position adjustment screw 464b, thereby enabling the tension of the timing belt 409 to be adjusted.

A case (fixed member) 46 having an L-shape in front view is fixed to the support plate 462 so as to cover the rotational force transmission mechanism, as shown in FIG. 11. A battery mounting portion 52 is provided on the upper side of the case 46. Furthermore, the control board 9 is mounted on the left side of the case 46 via the support stand 461. The drive mechanism 4 of the present embodiment further includes an encoder 493 that measures the number of rotations of the screw shaft 42. The encoder 493 includes an encoder disk 493a fixed to the left side of the pulley 429 of the screw shaft 42, and a photointerrupter 493b fixed to the case 46 and provided with a light emitting element and a light receiving element disposed through the encoder disk 493a.

With such a configuration, for example, as shown in FIG. 10 and FIG. 11, the position where the slider 43 pushes the push button 491a of the microswitch 491, that is, the position where the first wire gripping body 21 and the second wire gripping body 22 are separated most from each other (the second position) can be specified as a position where the encoder 493 starts measuring the number of rotations of the screw shaft 42.

The thickness (outer diameter) of the coated electric wire (wire-like body) 700 gripped by the wire gripping portion 2 can be measured by measuring the number of rotations of the screw shaft 42 by the encoder 493 using this position as a base point. The type of the coated electric wire 700 can be detected by comparing the measurement results with a database.

That is, a wire type detection mechanism is configured by the encoder 493 that measures the number of rotations of the screw shaft 42 and the microswitch (position sensor) 491 that specifies the position where the encoder 493 starts measuring the number of rotations of the screw shaft 42.

On the other hand, in the case where the slider 43 pushes the push button 492a of the microswitch 492, the first wire gripping body 21 and the second wire gripping body 22 are in the closest state, so that it can be configured to stop the energization to the motor 41. This prevents the motor 41 from rotating unnecessarily, and thus makes it possible to preferably prevent the motor 41 from being deteriorated and damaged.

In addition, the position sensor that specifies the position at which the encoder 493 starts measuring the number of rotations of the screw shaft 42 is not limited to the microswitch 491, but may be an optical sensor, a magnetic sensor, or the like as long as it can detect the position of the slider 43.

Furthermore, the encoder 493 is not limited to an optical type, and may be, for example, a mechanical (contact) type, a magnetic type, an electromagnetic induction type, and the like.

The wire gripper 1 of the second embodiment can also provide the same functions and effects as those of the wire gripper 1 of the first embodiment described above.

In addition, the wire type detection mechanism that detects the type of the coated electric wire (wire-like body) 700 gripped by the wire gripping portion 2 is not limited to the above configuration, and can also be configured, for example, by a pressure sensor provided in the arc-shaped groove 21b formed on the lower surface of the first wire gripping body 21 and the arc-shaped groove 22b formed on the upper surface of the second wire gripping body 22, a sensor that measures the distance between the first wire gripping body 21 and the second wire gripping body 22, etc.

As described above, according to the present disclosure, the gripping operation of the coated electric wire 700 by the wire gripper 1 is configured to be performed by the drive mechanism 4 having the motor 41. Thus, the wire gripper 1 itself assists in works requiring a large force, resulting in good operability.

In addition, whereas conventionally two workers on a bucket in the air are required to work, it becomes possible for a single worker to work on the bucket in the air, thus improving workability. In addition, the remaining worker can grasp the work status of the worker on the bucket from the ground and give accurate instructions, thus improving safety.

Furthermore, by attaching various sensors to the wire gripper 1, data obtained during work can be transmitted to an external terminal (such as a tablet terminal, etc.) via the communication unit 91 of the control board 9 and can be stored there. Then, it is possible to check the work history and manage the need for repairs, etc. to the wire gripper 1 based on the obtained data, which is also preferable from the viewpoint of improving safety. The external terminal may be a foot switch, a voice recognition device, etc. In this case, even in the case of working alone, both hands can be freed when operating the wire gripper 1.

In addition, even in the case where a plurality of coated electric wires (wire-like bodies) 700 are simultaneously worked on using the respective wire tensioning devices 100, the wire tensioning work and the like can be performed using a single external terminal.

In addition, the present disclosure may be provided in each of the following aspects.
(1) A wire gripper adapted to be used to grip a wire-like body, comprising: a wire gripping portion including a first wire gripping body and a second wire gripping body disposed opposite to the first wire gripping body; a displacement mechanism configured to relatively displace the first wire gripping body and the second wire gripping body between a first position allowing the wire-like body to be gripped and a second position allowing the gripped wire-like body to be released; and a drive mechanism including a motor that actuates the displacement mechanism.
(2) The wire gripper according to (1), wherein: the displacement mechanism includes a pair of first link pieces rotatably attached to the first wire gripping body, a pair of second link pieces rotatably attached to the second wire gripping body, a first connection structure that rotatably connects one of the first link pieces and one of the second link pieces corresponding to the one of the first link pieces, and a second connection structure that rotatably connects another of the first link pieces and another of the second link pieces corresponding to the other of the first link pieces, and the drive mechanism is configured to bring the first connection structure and the second connection structure close to each other and to separate the first connection structure from the second connection structure by rotation of the motor, so that the first wire gripping body and the second wire gripping body are displaced between the first position and the second position.
(3) The wire gripper according to (2), wherein: the drive mechanism includes a screw shaft connected to a rotary shaft of the motor and a slider that moves along the screw shaft by rotation of the screw shaft, and the first connection structure is fixed to the motor, and the second connection structure is fixed to the slider.
(4) The wire gripper according to (2), wherein: the drive mechanism includes a screw shaft provided adjacent to a rotary shaft of the motor, a rotational force transmission mechanism that transmits a rotational force of the rotary shaft of the motor to the screw shaft, and a slider that moves along the screw shaft by rotation of the screw shaft, and the first connection structure is fixed to the motor, and the second connection structure is fixed to the slider.
(5) The wire gripper according to any one of (2) to (4), wherein: the pair of first link pieces is provided at an end on a side of the first wire gripping body and includes tooth portions meshed with each other.
(6) The wire gripper according to any one of (2) to (5), wherein: the pair of second link pieces is provided at an end on a side of the second wire gripping body and includes tooth portions meshed with each other.
(7) The wire gripper according to any one of (2) to (6), further comprising: a control board that controls at least the motor, wherein the drive mechanism further includes a case that houses the motor and mounts the control board.
(8) The wire gripper according to any one of (2) to (7), wherein: the second connection structure further includes a connecting member that pulls the second connection structure in a direction separate from the first connection structure.
(9) The wire gripper according to any one of (2) to (8), further comprising: a wire type detection mechanism that detects a type of the wire-like body gripped by the wire gripping portion and includes an encoder that measures a number of rotations of the screw shaft and a position sensor that specifies a position where the encoder starts measuring a number of rotations of the screw shaft.
(10) The wire gripper according to any one of (1) to (9), further comprising: a power supply part that supplies power to at least the motor.
(11) The wire gripper according to any one of (1) to (10), further comprising: a wire type detection mechanism that detects a type of the wire-like body gripped by the wire gripping portion.
(12) A wire tensioning device, comprising: a pair of wire grippers each configured by the wire gripper according to any one of (1) to (11); and an expander having the pair of wire grippers coupled to both ends thereof and being configured so that the pair of wire grippers gripping the wire-like body is brought close to each other and is separated from each other.

Of course, the present disclosure is not limited to the above aspects.

Finally, various embodiments of the present disclosure have been described, but these are presented as examples and are not intended to limit the scope of the invention. Novel embodiments can be implemented in various other forms, and various omissions, replacements, and modifications can be made within the scope of the spirit of the invention. The embodiments and its modifications are included in the scope and the spirit of the invention and are included in the scope of the invention described in claims and the equivalent scope thereof.

For example, any of the configurations of the first and second embodiments described above may be appropriately combined.

1. A wire gripper adapted to be used to grip a wire-like body, comprising:
a wire gripping portion including a first wire gripping body and a second wire gripping body disposed opposite to the first wire gripping body;
a displacement mechanism configured to relatively displace the first wire gripping body and the second wire gripping body between a first position allowing the wire-like body to be gripped and a second position allowing the gripped wire-like body to be released; and
a drive mechanism including a motor that actuates the displacement mechanism.

2. The wire gripper according to claim 1, wherein:
the displacement mechanism includes a pair of first link pieces rotatably attached to the first wire gripping body, a pair of second link pieces rotatably attached to the second wire gripping body, a first connection structure that rotatably connects one of the first link pieces and one of the second link pieces corresponding to the one of the first link pieces, and a second connection structure that rotatably connects another of the first link pieces and another of the second link pieces corresponding to the other of the first link pieces, and
the drive mechanism is configured to bring the first connection structure and the second connection structure close to each other and to separate the first connection structure from the second connection structure by rotation of the motor, so that the first wire gripping body and the second wire gripping body are displaced between the first position and the second position.

3. The wire gripper according to claim 2, wherein:
the drive mechanism includes a screw shaft connected to a rotary shaft of the motor and a slider that moves along the screw shaft by rotation of the screw shaft, and
the first connection structure is fixed to the motor, and the second connection structure is fixed to the slider.

4. The wire gripper according to claim 2, wherein:
the drive mechanism includes a screw shaft provided adjacent to a rotary shaft of the motor, a rotational force transmission mechanism that transmits a rotational force of the rotary shaft of the motor to the screw shaft, and a slider that moves along the screw shaft by rotation of the screw shaft, and
the first connection structure is fixed to the motor, and the second connection structure is fixed to the slider.

5. The wire gripper according to claim 2, wherein:
the pair of first link pieces is provided at an end on a side of the first wire gripping body and includes tooth portions meshed with each other.

6. The wire gripper according to claim 2, wherein:
the pair of second link pieces is provided at an end on a side of the second wire gripping body and includes tooth portions meshed with each other.

7. The wire gripper according to claim 2, further comprising:
a control board that controls at least the motor, wherein
the drive mechanism further includes a case that houses the motor and mounts the control board.

8. The wire gripper according to claim 2, wherein:
the second connection structure further includes a connecting member that pulls the second connection structure in a direction separate from the first connection structure.

9. The wire gripper according to claim 3, further comprising:
a wire type detection mechanism that detects a type of the wire-like body gripped by the wire gripping portion and includes an encoder that measures a number of rotations of the screw shaft and a position sensor that specifies a position where the encoder starts measuring a number of rotations of the screw shaft.

10. The wire gripper according to claim 1, further comprising:
a power supply part that supplies power to at least the motor.

11. The wire gripper according to claim 1, further comprising:
a wire type detection mechanism that detects a type of the wire-like body gripped by the wire gripping portion.

12. A wire tensioning device, comprising:
a pair of wire grippers each configured by the wire gripper according to claim 1; and
an expander having the pair of wire grippers coupled to both ends thereof and being configured so that the pair of wire grippers gripping the wire-like body is brought close to each other and is separated from each other.
